(19) United States
(12) Patent Application Publication
(10) Pub. No.: US 2013/0337268 A1
(43) Pub. Date: Dec. 19, 2013

(54) INSULATING EPOXY RESIN COMPOSITION, INSULATING FILM MANUFACTURED THEREFROM, AND MULTILAYER PRINTED CIRCUIT BOARD HAVING THE SAME

(71) Applicants: Kee Su Jeon, Gyunggi-do (KR); Ji Hye Shim, Gyunggi-do (KR); Sa Yong Lee, Gyunggi-do (KR); Jin Young Kim, Gyunggi-do (KR); Jeong Kyu Lee, Gyunggi-do (KR)

(72) Inventors: Kee Su Jeon, Gyunggi-do (KR); Ji Hye Shim, Gyunggi-do (KR); Sa Yong Lee, Gyunggi-do (KR); Jin Young Kim, Gyunggi-do (KR); Jeong Kyu Lee, Gyunggi-do (KR)

(73) Assignee: Samsung Electro-Mechanics Co., Ltd., Gyunggi-do (KR)

(21) Appl. No.: 13/584,727

(22) Filed: Aug. 13, 2012

(30) Foreign Application Priority Data
Jun. 14, 2012 (KR) 10-2012-0063860

(51) Int. Cl. C08L 63/04; C08L 67/03; C08L 63/02; C08L 61/16; C08L 81/06; C08L 71/00; C08L 69/00; B32B 27/38; C08L 79/08

(52) U.S. Cl. 428/413; 523/435; 523/427

(57) ABSTRACT

Disclosed herein are an insulating resin composition, an insulating film manufactured therefrom, and a multilayer printed circuit board, and more specifically, in a build-up manner of multilayer printed circuit board, an insulating epoxy resin composition including a liquid crystal oligomer or the like capable of decreasing a dissipation factor, a dielectric constant, and a coefficient of thermal expansion, an insulating film manfuactured by using the insulating epoxy resin composition, and a multilayer printed circuit board having multiple layers obtained by allowing inner circuits formed of copper (Cu) to be insulated by using the insulating film.

### CROSS REFERENCE TO RELATED APPLICATION

This application claims the benefit of Korean Patent Application No. 10-2012-0063860, filed on Jun. 14, 2012, entitled “Insulting Epoxy Resin Composition, Insulting Film Made Therefrom, and Multilayer Printed Circuit Board Having the Same”, which is hereby incorporated by reference in its entirety into this application.

### BACKGROUND OF THE INVENTION

1. Technical Field

The present invention relates to an insulating epoxy resin composition, an insulating film manufactured therefrom, and a multilayer printed circuit board having the same.

2. Description of the Related Art

As electronic devices have many functions due to the development of electronic devices and request for complicated functions, the devices are required to have a higher density, a higher function, a smaller size, a smaller thickness, and a smaller weight, and at the same time, they are also designed to be used at a high frequency. Also, in a printed circuit board, as a multiple build-up layer is multi-layered to thereby require finer wirings and a higher density of wirings. Therefore, the insulating layer becomes highly functional and highly dense, and the references for electrical, mechanical, and thermal properties are more and more strict.

Hence, various methods have been studied in order to enhance mechanical, thermal, and electric properties of an insulating layer of a buildup layer used in a multilayer printed circuit board in the electronic device. Specifically, a coefficient of thermal expansion related to the warpage defect occurring in a substrate and a dissipation factor related to the heating defect occurring at a high frequency are important among physical properties requested in the insulating layer, and several studies and developments for lowering values thereof are progressing.

For example, Patent Document 1 discloses that a resin composition containing a naphthylene ether type epoxy resin in a cyanate ester resin has an improved dissipation factor, and Patent Document 2 disclosed that a resin composition containing liquid crystal polyester and an epoxy group—containing ethylene copolymer has an improved dissipation factor.

However, recently, an insulating film for buildup has requested lower dissipation factor and coefficient of thermal expansion (CTE).
Patent Document 1: Korean Patent Laid-Open Publication No. 2011-0068877
Patent Document 2: Korean Patent Laid-Open Publication No. 2006-0131916

### SUMMARY OF THE INVENTION

In the present invention, an insulating film obtained by mixing a liquid crystal oligomer having a particular structure, an epoxy resin, an active ester hardener, and an inorganic filler may have an improved dissipation factor and an excellent coefficient of thermal expansion. Based on this, the present invention was achieved.

The present invention has been made in an effort to provide an insulating epoxy resin composition having low dissipation factor and coefficient of thermal expansion.

The present invention also has been made in an effort to provide an insulating film manufactured from the insulating epoxy resin composition, capable of forming a fine pattern and having a low coefficient of thermal expansion.

The present invention also has been made in an effort to provide a multilayer printed circuit board having the insulating film.

According to a preferred embodiment of the present invention, there is provided an insulating epoxy resin composition, including:

a liquid crystal oligomer (A) represented by Chemical Formula 1 below;

an epoxy resin (B);

an active ester hardener (C); and

an inorganic filler (D):

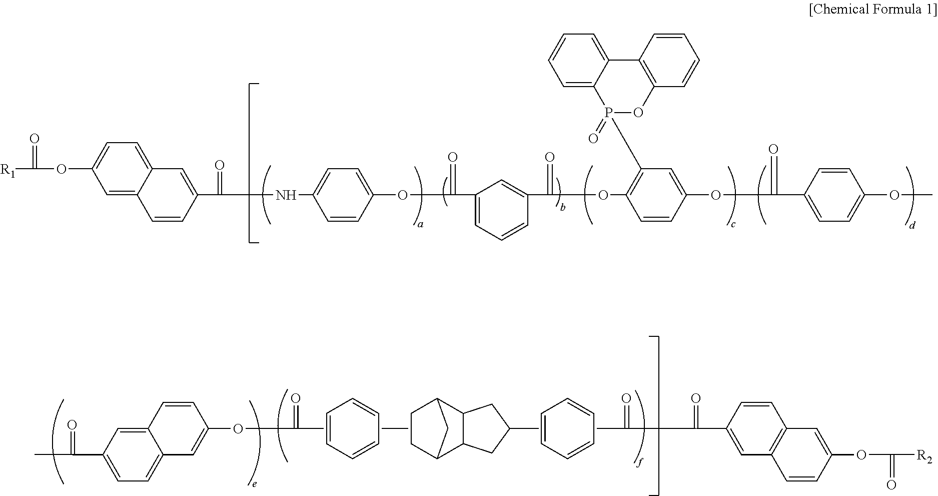

In wherein Chemical Formula 1, a is an integer of 13˜26, b is an integer of 13˜26, c is an integer of 9˜21, d is an integer of 10˜30, e is an integer of 10˜30, and f is an integer of 13˜17, and R₁ and R₂, which are identical or different, are independently a C1˜C20 alkyl group.

The liquid crystal oligomer (A) may be contained in 2 to 10 wt %; the epoxy resin (B) may be contained in 5 to 25 wt %; the active ester hardener (C) may be contained in 5 to 20 wt %; and the inorganic filler (D) may be contained in 50 to 85 wt %.

The insulating epoxy resin composition may further include at least one hardening accelerant (E) selected from the group consisting of a metal based hardening accelerant, an imidazole based hardening accelerant, and an amine based hardening accelerant.

The insulating epoxy resin composition may further include at least one thermoplastic resin (F) selected from the group consisting of a phenoxy resin, a polyimide resin, a polyamideimide (PAI) resin, a polyetherimide (PEI) resin, a polysulfone (PS) resin, a polyethersulfone (PES) resin, a polyphenyleneether (PPE) resin, a polycarbonate (PC) resin, a polyetheretherketone (PEEK) resin, and a polyester resin.

The liquid crystal oligomer may have a number average molecular weight of 2,500˜6,500.

Here, in the liquid crystal oligomer, an amide may be contained in a molar ratio of 12˜30 mole %.

The active ester hardener may be obtained by allowing a hardener containing a hydroxy group to react with a compound represented by Chemical Formula 2 below:

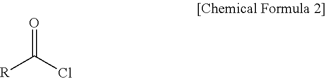

In Chemical Formula 2, R is a C1˜C20 alkyl group, a benzyl group, or a naphthalene group.

The hardener containing a hydroxy group may be a phenolic novolac hardener, a dicyclopentadiene based hardener, or a bisphenol A phenolic hardener.

The epoxy resin may be at least one selected from a naphthalene based epoxy resin, a bisphenol A epoxy resin, a phenol novolac epoxy resin, a cresole novolac epoxy resin, a rubber modified epoxy resin, and a phosphorous-based epoxy resin.

The inorganic filler may be at least one selected from the group consisting of silica, alumina, barium sulfate, talc, mud, a mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titan oxide, barium zirconate, and calcium zirconate.

According to another preferred embodiment of the present invention, there is provided an insulating film manufactured by the insulating epoxy resin composition.

According to another preferred embodiment of the present invention, there is provided a multilayer printed circuit board including the insulating film.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a cross-sectional view of a general printed circuit board to which an insulating epoxy resin composition according to the present invention is applicable.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with to reference to the attached drawings.

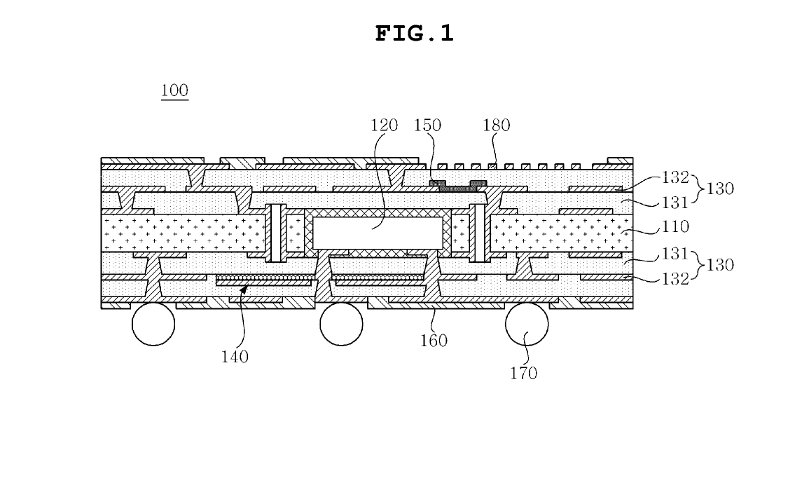

FIG. 1 is a cross-sectional view of a general printed circuit board to which an insulating epoxy resin composition according to the present invention is applicable. Referring to FIG. 1, a printed circuit board 100 may be an embedded substrate in which electronic components are embedded. Specifically, the printed circuit board 100 may include an insulator 110 having a cavity, an electronic component 120 disposed inside the cavity, and a buildup layer 130 disposed on at least one of an upper surface and a lower surface of the insulator 110 including the electronic component 120. The buildup layer 130 may include an insulating layer 131 disposed on at least one of the upper surface and the lower surfaces of the insulator 110 and a circuit layer 132 disposed on the insulating layer 131 to form an interlayer connection thereto.

Here, an example of the electronic component 120 may be an active device such as a semiconductor device. In addition, the printed circuit board 100 may not have only one electronic component 120 therein but further have one or more additive electronic components, such as a capacitor 140, a resistor element 150, and the like. In the exemplary embodiment of the present invention, the type or number of electronic components is not limited. Here, the insulator 110 and the insulating layer 131 may serve to insulate between circuit layers or between electronic components, and also serve as a structural member for maintaining the rigidity of the package.

Here, when the wiring density of the printed circuit board 100 is increased, the insulator 110 and the insulating layer 131 require low dielectric constant characteristics in order to reduce noise between the circuit layers and parasitic capacitance, and the insulator 110 and the insulating layer 131 also require low dielectric loss characteristics in order to increase insulating characteristics.

As such, at least one of the insulator 110 and the insulating layer 131 needs to decrease the dielectric constant, the dielectric loss, and the like and have rigidity. In the present invention, in order to lower the dissipation factor, dielectric constant, and coefficient of thermal expansion of the insulating layer, the insulating layer may be formed of an insulating epoxy resin composition containing a liquid crystal oligomer (A) represented by Chemical Formula 1 below, an epoxy resin (B), an active ester hardener (C), and an inorganic filler (D).

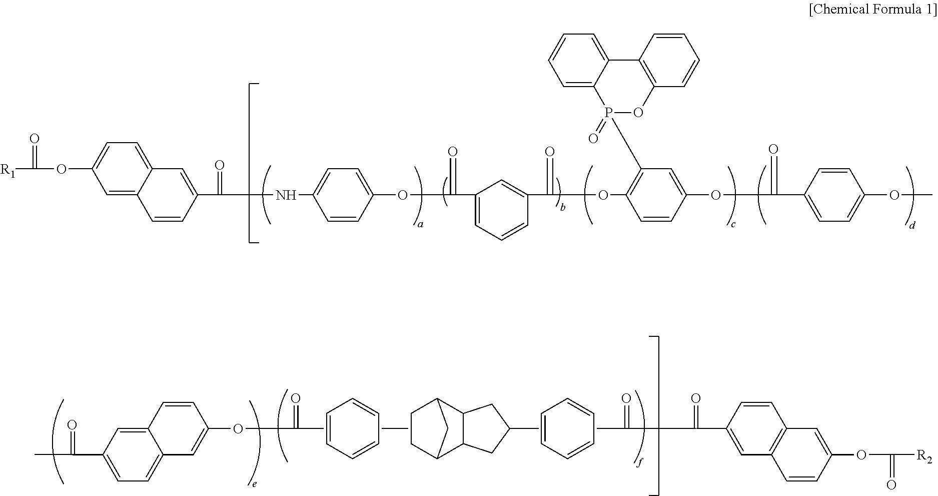

In Chemical Formula 1, a is an integer of 13˜26, b is an integer of 13˜26, c is an integer of 9˜21, d is an integer of 10˜30, e is an integer of 10˜30, and f is an integer of 13˜17, and R₁ and R₂, which are identical or different, are independently C1˜C20 alkyl.

The liquid crystal oligomer (A) represented by Chemical Formula 1 above may contain ester groups both ends of a main chain in order to improve the dissipation factor and the dielectric constant contain a phosphorous component imparting flame retardancy; and contain a naphthalene group for crystallinity.

The liquid crystal oligomer has a number average molecular weight of, preferably, 2,500 to 6,500 g/mol, and more preferably, 3,000 to 6,000 g/mol. If the number average molecular weight thereof is below 2,500 g/mol, the resin composition may be vulnerable to mechanical properties. If the number average molecular weight thereof is above 6,500 g/mol, solubility of the resin composition may be decreased. In addition, the molar ratio of amide in the liquid crystal oligomer molecule is preferably 12 to 30 mole %, and more preferably 15 to 25 mole %. If the molar ratio thereof is below 12 mole %, the solubility of the resin composition may be decreased. If the molar ratio thereof is above 30 mole %, hygroscopic property of the resin composition may be increased.

The use amount of liquid crystal oligomer (A) is preferably 2 to 10 wt %, and more preferably 3 to 7 wt %. If the use amount thereof is below 2 wt %, the dissipation factor and dielectric constant of the resin composition may be slightly improved. If the use amount thereof is above 10 wt %, mechanical properties of the resin composition may be decreased.

The resin composition according to the present invention may contain an epoxy resin (B) in order to improve handling property of the resin composition as an adhering film after drying. The epoxy resin means a material that contains, but is not particularly limited to, at least one epoxy group in a molecule thereof, and preferably at least two epoxy groups in a molecule thereof.

Examples of the epoxy resin may include, but are not particularly limited to, a bisphenol A epoxy resin, a bisphenol F epoxy resin, a bisphenol S epoxy resin, a phenol novolac epoxy resin, an alkylphenol novolac epoxy resin, a biphenyl epoxy resin, an aralkyl epoxy resin, a dicyclopentadiene epoxy resin, a naphthalene epoxy resin, a naphtol epoxy resin, an epoxy resin of a condensate of phenol and aromatic aldehyde having a phenol hydroxyl group, a biphenylaralkyl epoxy resin, a fluorene epoxy resin, a xanthene epoxy resin, a triglycidyl isocianurate resin, a rubber modified epoxy resin, and a phosphorus based epoxy resin, and preferable are the naphthalene based epoxy resin, bisphenol A epoxy resin, phenol novolac epoxy resin, cresol novolac epoxy resin, rubber modified epoxy resin, and phosphorous based epoxy resin. One kind or two or more kinds of epoxy resins may be used in a mixture.

The use amount of epoxy resin (B) is preferable 5 to 25 wt %. If the use amount thereof is below 5 wt %, handling property of the resin composition may be deteriorated. If the use amount thereof is above 25 wt %, the added amount of other components is relatively small, and thus, the dissipation factor, dielectric constant, and coefficient of thermal expansion of the resin composition may be little improved.

Meanwhile, the resin composition according to the present invention contains the active ester hardener (C) in order to further improve dielectric characteristics thereof. The active ester hardener has an active ester group, and the kind and molecular weight of the active ester harder are not limited as long as it can react with epoxy. However, an active ester hardener containing two or more active ester groups in one molecule and having a functional group reacting with an epoxy group is preferable, and may be for example a phenol ester compound, a thiophenol ester compound, an N-hydroxyamine ester compound, a heterocyclic hydroxy group-esterified compound, or the like. Particularly, in view of improvement in heat resistance, an active ester compound obtained from a carboxylic acid compound and a hydroxy compound is preferable, and an active ester compound obtained from a carboxylic acid compound and a phenol compound or a naphtol compound is more preferable. In addition, an aromatic compound having two or more active ester groups in one molecule, obtained from a carboxylic acid compound and an aromatic compound having a phenolic hydroxyl group is still more preferable, and an aromatic compound having two or more active ester groups in one molecule, obtained from a compound having two or more carboxylic acids in one molecule and an aromatic compound having a phenolic hydroxyl group is particularly preferable. Also, a straight chain type or a multi-branched type is preferable. Any compound that has two or more carboxylic acids in one molecule may improve heat resistance. Specific examples of the carboxylic acid compound may include benzoic acid, acetic acid, succinic acid, maleic acid, itaconic acid, phthalic acid, isophthalic acid, terephthalic acid, pyromellitic acid, and the like. Among them, in view of improving heat resistance, succinic acid, maleic acid, itaconic acid, phthalic acid, isophthalic acid, and terephthalic acid are preferable, and isophthalic acid and terephthalic acid are more preferable. Specific examples of the phenol compound or naphtol compound may include hydroquinone, resorcin, bisphenol A, bisphenol F, bisphenol S, phenolphthalein, methylated bisphenol A, methylated bisphenol F, methylated bisphenol S, phenol, o-cresol, m-cresol, p-cresol, catechol, α-naphthol, β-naphthol, 1,5-dihydroxy naphthalene, 1,6-dihydroxy naphthalene, 2,6-dihydroxy naphthalene, dihydroxy benzophenone, trihydroxy benzophenone, tetrahydroxy benzophenone, phloroglucinol, benzenetriol, dicyclopentadienyldiphenol, phenol novolac, and the like. Among them, in order to improve heat resistance and solubility, catechol, α-naphthol, β-naphthol, 1,5-dihydroxy naphthalene, 1,6-dihydroxy naphthalene, 2,6-dihydroxy naphthalene, dihydroxy benzophenone, trihydroxy benzophenone, tetrahydroxy benzophenone, phloroglucinol, benzenetriol, dicyclopentadienyldiphenol, and phenol novolac are preferable; α-naphthol, β-naphthol, 1,5-dihydroxy naphthalene, 1,6-dihydroxy naphthalene, 2,6-dihydroxy naphthalene, dihydroxy benzophenone, trihydroxy benzophenone, tetrahydroxy benzophenone, dicyclopentadienyldiphenol, and phenol novolac are more preferable; and α-naphthol, β-naphthol, and dicycopentadienyl phenol, trihydroxybenzophenone, tetrahydroxybenzophenone, dicyclopentadienyldiphenol, and phenol novolac are particularly preferable; and α-naphthol, β-naphthol, and dicycopentadienyl phenol are particularly preferable. One kind or two or more kinds of epoxy resins may be used in combination.

In addition, the active ester hardener may be prepared by allowing a compound represented by Chemical Formula 2 below to react with a hardener before reaction including a hydroxy group, and the kind of hardener before reaction is not particularly limited.

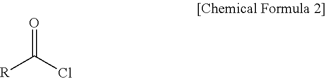

In Chemical Formula 2, R is a C1˜C20 alkyl group, a benzyl group, or a naphthalene group. Examples of the hardener before reaction may include, but are not particularly limited to, a to phenolic novolac hardener, a dicylcopentadiene (DCPD) based hardener, a bisphenol A phenolic hardener, and the like, and R in Chemical Formula 2 is not particularly limited, but benzyl and naphthalene are preferable in view of purchase and synthesis.

The use amount of an active ester hardener (C) is preferably 5 to 20 wt %. If the use amount thereof is below 5 wt %, dielectric characteristics can be little improved. If the use amount thereof is above 20 wt %, working operability may be deteriorated.

The resin composition according to the preset invention contains an inorganic filler in order to lower the coefficient of thermal expansion (CTE) of the insulating resin. The inorganic filer (D) lowers the coefficient of thermal expansion, and the content ratio of the inorganic filler (D) is preferably 50˜85 wt % in the resin composition, according to the requested characteristics, considering the use and the like of the resin composition. If the content ratio thereof is below 50 wt %, the dissipation factor of the resin composition may be lowered and the coefficient of thermal expansion of the resin composition may be increased. If the content ratio thereof is above 85 wt %, adhering strength of the resin composition may be deteriorated. The content of inorganic filler is preferably at least 60 wt % based on solids of the entire resin composition. Specific examples of the inorganic filler used in the present invention may include silica, alumina, barium sulfate, talc, mud, a mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titan oxide, barium zirconate, calcium zirconate, and the like, which are used alone or in combination of two or more thereof. Particularly, preferable is silica having a low dissipation factor.

In addition, if the inorganic filler has an average particle size of Sum or larger, a fine pattern is difficult to stably form when a circuit pattern is formed in a conductor layer. Hence, the average particle size of the inorganic filler is preferably 5 μm or smaller. In addition, the inorganic filler is preferably surface-treated with a surface treating agent such as a silane coupling agent, in order to improve the moisture resistance of the resin composition. More preferable is silica having a diameter of 0.2 to 2 μm.

Also, the resin composition of the present invention can perform efficient hardening by including a hardening accelerant (E). Examples of the hardening accelerant used in the present invention may include a metal based hardening accelerant, an imidazole based hardening accelerant, an amine based hardening accelerant, and the like, and one or combination of two or more thereof may be used in a general amount used in the art.

Examples of the metal based hardening accelerant may include, but is not particularly limited to, an organic metal complex of a metal, such as, cobalt, copper, zinc, iron, nickel, manganese, tin, or the like, and an organic metal salt. Specific examples of the organic metal complex may include an organic cobalt complex such as cobalt (II) acetylacetonate, cobalt (III) acetylacetonate, and the like, an organic copper complex such as copper (II) acetylacetonate or the like, an organic zinc complex such as zinc (II) acetylacetonate or the like, an organic iron complex such as iron (III) acetylacetonate or the like, an organic nickel complex such as nickel (II) acetylacetonate or the like, an organic manganese complex such as manganese (II) acetylacetonate or the like, and the like. Examples of the organic metal salt may include zinc octylate, tin octylate, zinc naphthenate, cobalt naphthenate, tin stearate, zinc stearate, and the like. As the metal based hardening accelerator, in view of hardening property and solvent solubility, cobalt (II) acetylacetonate, cobalt (III) acetylacetonate, zinc (II) acetylacetonate, to zinc naphthenate, and iron (III) acetylacetonate are preferable, and cobalt (II) acetylacetonate and zinc naphthenate are more preferable. One kind or two or more kinds of metal based hardening accelerants may be used in combination.

Examples of the imidazole based hardening accelerant may include, but are not particularly limited to, an imidazole compound, such as, 2-methyl imidazole, 2-undecyl imidazol, 2-heptadecyl imidazole, 1,2-dimethyl imidazole, 2-ethyl-4-methyl imidazole, 1,2-dimethyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1-cyanoethyl-2-methyl imidazole, 1-cyanoethyl-2-undecyl imidazole, 1-cyanoethyl-2-ethyl-4-methyl imidazole, 1-cyanoethyl-2-phenyl imidazole, 1-cyanoethyl-2-undencyl imidazolium trimellitate, 1-cyanoethyl-2-phenyl imidazolium trimellitate, 2,4-diamino-6-[2′-methyl imidazolyl-(1′)]ethyl-s-triazine, 2,4-diamino-6-[2′-undecyl imidazolyl-(1′)]-ethyl-s-triazine, 2,4-diamin-6-[2′-ethyl-4′-methyl imidazolyl-(1′)]ethyl-s-triazine, 2,4-diamino-6-[2′-methyl imidazolyl-(1′)]-ethyl-s-triazine isocyanuric acid adduct, 2-phenyl imidazole isocyanuric acid adduct, 2-phenyl-4,5-dihydroxymethyl imidazole, 2-phenyl-4-methyl-5-hydroxy methyl imidazole, 2,3-dihydroxy-1H-pyrrolo[1,2-a]benz imidazole, 1-dodecyl-2-methyl-3-benzyl imidazolium chloride, 2-methyl imidazolin, 2-phenyl imidazolin, or the like, and an adduct body of the imidazole compound and an epoxy resin. One kind or two or more kinds of imidazole hardening accelerants may be used in combination.

Examples of the amine based hardening accelerants may include, but are not particularly limited to, an amine compound, for example, trialkyl amine such as trimethylamine, tributylamine, or the like, 4-dimethylaminopyridine, benzyldimethyl amine, 2,4,6-tris(dimethylaminomethyl)phenol, 1,8-diazabicyclo(5,4,0)-undecene (hereinafter, referred to as DBU), or the like. One kind or two or more kinds of amine based hardening accelerants may be used in combination.

The resin composition of the present invention may selectively include a thermoplastic resin (F) in order to improve film formability of the resin composition or improve mechanical property of the hardened material. Examples of the thermoplastic resin may include a phenoxy resin, a polyimide resin, a polyamideimide (PAI) resin, a polyetherimide (PEI) resin, a polysulfone (PS) resin, a polyethersulfone (PES) resin, a polyphenyleneether (PPE) resin, a polycarbonate (PC) resin, a polyetheretherketone (PEEK) resin, a polyester resin, and the like. These thermoplastic resins may be used alone or in mixture of two or more. The average weight molecular weight of the thermoplastic resin is preferably in a range of 5,000 to 200,000. If the average weight molecular weight of the thermoplastic resin is below 5,000, an improving effect of film formability and mechanical strength is not sufficiently exhibited. If the average weight molecular weight thereof is above 200,000, compatibility with a liquid crystal oligomer and an epoxy resin is not sufficient, the surface unevenness after hardening becomes larger, and high-density fine wirings are difficult to form. The weight average molecular weight is measured at a column temperature of 40° C. by using LC-9A/RID-6A from the Shimadzu Corporation as a measuring apparatus, Shodex K-800P/K-804L/K-804L from the Showa Denko as a column, and chloroform (CHCl₃) as a mobile phase, and then calculated by using a Calibration Curve of standard polystyrene.

In the case where a thermoplastic resin (F) is blended with the resin composition of the present invention, the content of thermoplastic resin in the resin composition is, but is not particularly limited to, preferably 0.1 to 10 wt %, and more preferably 1 to 5 wt %, based on 100 wt % of non-volatile matter in the resin composition. If the content of thermoplastic resin is below 0.1 wt %, an improving effect of film formability or mechanical strength is not exhibited. If the content thereof is above 10 wt %, molten viscosity may tend to be increased and surface roughness of an insulating layer after a wet roughening process may tend to be increased.

The insulating resin composition according to the present invention is mixed in the presence of an organic solvent. Examples of the organic solvent, considering solubility and miscibility of the resin and other additives used in the present invention, may include 2-methoxy ethanol, acetone, methyl ethyl ketone, cyclohexanone, ethyl acetate, butyl acetate, cellosolve acetate, propylene glycol monomethyl ether acetate, ethylene glycol monobutyl ether acetate, cellosolve, butyl cellosolve, carbitol, butyl carbitol, xylene, dimethyl formamide, and dimethyl acetamide, but are not particularly limited thereto.

Besides, the present invention may further include, as necessary, other known leveling agents and/or flame retardants by those skilled in the art within the technical scope of the present invention.

According to the insulating resin composition of the present invention, a semisolid phase dry film can be prepared by any general method known in the art. For example, a film may be manufactured by using a roll coater, a curtain coater, or the like, and then dried. Then, the film is applied onto a substrate, to thereby be used as an insulating layer (or an insulating film) when the multilayer printed circuit board is manufactured in a build-up manner. This insulating film has a low coefficient of thermal expansion (CTE) of 20 ppm/° C. or lower.

As such, the insulating film formed of the insulating resin composition of the present invention is laminated on a copper clad laminate (CCL) used as an inner layer when the multilayer printed circuit board is manufactured. For example, the multilayer printed circuit board may be manufactured by forming the insulating film of the insulating resin composition on a patterned inner layer circuit board; hardening it at a temperature of 80 to 110° C. for 20 to 30 minutes; performing a desmear process, and then forming a circuit layer through an electroplating process.

Hereinafter, the present invention will be described in more detail with reference to the following examples and comparative examples, but the scope of the present invention is not limited thereto.

### Example 1

A silica slurry having a concentration of 70 wt % was prepared by dispersing silica having a size distribution of an average particle size of 0.2 to 1 μm in 2-methoxy ethanol. After that, a mixture was prepared by adding 400 g of a novolac based epoxy resin (KUKDO Chemical Company, YDCN-500-01P) having an average epoxy equivalent of 100 to 300, 400 g of a naphthalene based epoxy resin (SE-80) having an average epoxy equivalent of 100 to 500, 200 g of a rubber modified epoxy resin (STRUKTOL, Polydis 3616) having an average epoxy equivalent of 200 to 500, and 220 g of a phenoxy resin having a molecular weight of 40,000 to 120,000 to 10,500 g of the prepared silica slurry, followed by stirring at room temperature by using a stirrer of 300 rpm.

After that, 810 g of active ester based hardener (DIC, HPC-8000-65T) and 360 g of a liquid crystal oligomer represented by Chemical Formula 1 (in Chemical Formula 1, molar ratio of a is 17, molar ratio of b is 17, molar ratio of c is 15, molar ratio of d is 20, molar ratio of e is 20, and molar ratio off is 17, R₁ and R₂ are all methyl), which is dissolved in dimethylacetamide, are further added to the mixture, and stirred at 300 rpm for 1 hour. Thereafter, 3 g of 2-ethyl-4-methyl imidazole and a leveling agent (BYK-337) were added thereto in 1.5 parts per hundred parts of resin (PHR) of the entire mixture, and stirred for 1 hour, thereby preparing the insulating resin composition.

### Example 2

A silica slurry having a concentration of 70 wt % was prepared by dispersing silica having a size distribution of an average particle size of 0.2 to 1 μm in 2-methoxy ethanol. After that, a mixture was prepared by adding 400 g of a novolac based epoxy resin (KUKDO Chemical Company, YDCN-500-01P) having an average epoxy equivalent of 100 to 300, 400 g of a naphthalene based epoxy resin (SE-80) having an average epoxy equivalent of 100 to 500, 100 g of a rubber modified epoxy resin (STRUKTOL, Polydis 3616) having an average epoxy equivalent of 200 to 500, and 220 g of a phenoxy resin having a molecular weight of 40,000 to 120,000 to 10,800 g of the prepared silica slurry, followed by stirring at room temperature by using a stirrer of 300 rpm. After that, 950 g of active ester based hardener (DIC, HPC-8000-65T) and 370 g of a liquid crystal oligomer used in Example 1, which is dissolved in dimethyl acetamide, are further added to the mixture, and stirred at 300 rpm for 1 hour. Thereafter, 3 g of 2-ethyl-4-methyl imidazole and a leveling agent (BYK-337) were added thereto in 1.5 PHR of the entire mixture, and stirred for 1 hour, thereby preparing the insulating resin composition.

### Example 3

A silica slurry having a concentration of 70 wt % was prepared by dispersing silica having a size distribution of an average particle size of 0.2 to 1 μm in 2-methoxy ethanol. After that, a mixture was prepared by adding 320 g of a novolac based epoxy resin (KUKDO Chemical Company, YDCN-500-01P) having an average epoxy equivalent of 100 to 300, 320 g of a naphthalene based epoxy resin (SE-80) having an average epoxy equivalent of 100 to 500, 70 g of a rubber modified epoxy resin (STRUKTOL, Polydis 3616) having an average epoxy equivalent of 200 to 500, and 190 g of a phenoxy resin having a molecular weight of 40,000 to 120,000 to 11,000 g of the prepared silica slurry, followed by stirring at room temperature by using a stirrer of 300 rpm. After that, 870 g of active ester based hardener (DIC, HPC-8000-651) and 320 g of a liquid crystal oligomer used in Example 1, which is dissolved in dimethyl acetamide, are further added to the mixture, and stirred at 300 rpm for 1 hour. Thereafter, 3 g of 2-ethyl-4-methyl imidazole and a leveling agent (BYK-337) were added thereto in 1.5 parts per hundred parts of resin (PHR) of the entire mixture, and stirred for 1 hour, thereby preparing the insulating resin composition.

### Comparative Example 1

A silica slurry having a concentration of 70 wt % was prepared by dispersing silica having a size distribution of an average particle size of 0.02 to 2 μm in 2-methoxy ethanol. After that, a mixture was prepared by adding 720 g of a novolac based epoxy resin (KUKDO Chemical Company, YDCN-500-01P) having an average epoxy equivalent of 100 to 300, 720 g of a naphthalene based epoxy resin (SE-80) having an average epoxy equivalent of 100 to 500, 360 g of a rubber modified epoxy resin (STRUKTOL, Polydis 3616) having an average epoxy equivalent of 200 to 500, and 320 g of a phenoxy resin having a molecular weight of 40,000 to 120,000 to 9,600 g of the prepared silica slurry, followed by stirring at room temperature by using a stiffer of 300 rpm. After that, 950 g of amino triazine based hardener (GUN EI CHEMICAL INDUSTRY CO., LTD., PS-6313) was added to the mixture, and then further stirred at 300 rpm for 1 hour. Thereafter, 5 g of 2-ethyl-4-methyl imidazole and a leveling agent (BYK-337) were added thereto in 1.5 PHR of the entire mixture, and stirred for 1 hour, thereby preparing the insulating resin composition.

### Comparative Example 2

A mixture was prepared by adding 9,600 g of a novolac based epoxy resin (KUKDO Chemical Company, YDCN-500-01P) having an average epoxy equivalent of 100 to 300, 720 g of a naphthalene based epoxy resin (SE-80) having an average epoxy equivalent of 100 to 500, 360 g of a rubber modified epoxy resin (STRUKTOL, Polydis 3616) having an average epoxy equivalent of 200 to 500, and 320 g of a phenoxy resin having a molecular weight of 40,000 to 120,000, to 9,600 g of the prepared silica slurry, which was prepared by dispersing silica having a size distribution of an average particle size of 0.2 to 1 μm in 2-methoxy ethanol, and then stirring it at room temperature by using a stirrer of 300 rpm. After that, 860 g of amino triazine based hardener (GUN EI CHEMICAL INDUSTRY CO., LTD., PS-6313) and 530 g of a liquid crystal oligomer dissolved in dimethyl acetamide are further added to the mixture, and then stirred at 300 rpm for 1 hour. Thereafter, 5 g of 2-ethyl-4-methyl imidazole and a leveling agent (BYK-337) were added thereto in 1.5 PHR of the entire mixture, and stirred for 1 hour, thereby preparing the insulating resin composition.

TABLE 1

| | | | | Comparative | Comparative |
|---|---|---|---|---|---|
| Unit (wt %) | Example 1 | Example 2 | Example 3 | Example 1 | Example 2 |
| Epoxy Resin | 8.4 | 8.2 | 6.2 | 17.2 | 14.4 |
| Rubber Modified Resin | 2.1 | 0.9 | 0.7 | 4.3 | 3.6 |
| Amino Triazine Based Hardener | 0 | 0 | 0 | 10.3 | 8.5 |
| Liquid Crystal Oligomer | 3.8 | 3.8 | 3 | 0 | 5.3 |
| Active Ester Hardener | 8.4 | 9.8 | 8.3 | 0 | 0 |
| Silica | 75 | 75 | 80 | 65 | 65 |
| Phenoxy Resin | 2.3 | 2.3 | 1.8 | 3.2 | 3.2 |
| Dissipation Factor (Df) | 0.0062 | 0.0054 | 0.0042 | 0.017 | 0.013 |
| Dielectric Constant (Dk) | 3.64 | 3.43 | 3.45 | 3.88 | 3.81 |
| Coefficient of Thermal Expansion | 18 | 15 | 12 | 25 | 21 |
| (CTE), ppm/° C. | | | | | |

As seen in Table 1 above, it can be seen that, as the result of comparing the dissipation factor, the dielectric constant, and the coefficient of thermal expansion of Comparative Example 1 where neither the liquid crystal oligomer nor the active ester hardener are added and Comparative Example 2 where only the liquid crystal oligomer is added with those of Examples 1 to 3, Examples 1 to 3 had relatively lower dissipation factor, dielectric constant, and coefficient of thermal expansion.

As for the experimental data above, the insulating resin composition was coated and dried on a copper foil, and then two sheets thereof were bonded by using a vacuum compressor, and hardened. After that, the dissipation factor and the dielectric constant thereof were measured at 1 MHz. An outer layer copper foil was removed by using nitric acid, and then the coefficient of thermal expansion thereof was measured by using thermal mechanical analysis.

As set forth above, the insulating epoxy resin composition and the insulating film manufactured therefrom can have a low dissipation factor, a dielectric constant, and a low coefficient of thermal expansion.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An insulating epoxy resin composition, comprising:
a liquid crystal oligomer (A) represented by Chemical Formula 1 below;
an epoxy resin (B);
an active ester hardener (C); and
an inorganic filler (D): 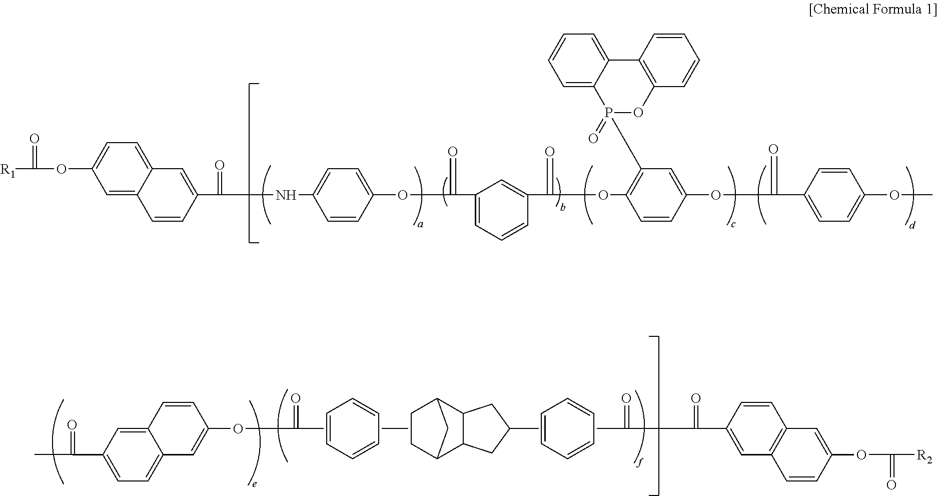
In wherein Chemical Formula 1, a is an integer of 13˜26, b is an integer of 13˜26, c is an integer of 9˜21, d is an integer of 10˜30, e is an integer of 10˜30, and f is an integer of 13˜17, and R₁ and R₂, which are identical or different, are independently a C1˜C20 alkyl group.

2. The insulating epoxy resin composition as set forth in claim 1, wherein the liquid crystal oligomer (A) is contained in 2 to 10 wt %; the epoxy resin (B) is contained in 5 to 25 wt %; the active ester hardener (C) is contained in 5 to 20 wt %; and the inorganic filler (D) is contained in 50 to 85 wt %.

3. The insulating epoxy resin composition as set forth in claim 1, further comprising at least one hardening accelerant (E) selected from the group consisting of a metal based hardening accelerant, an imidazole based hardening accelerant, and an amine based hardening accelerant.

4. The insulating epoxy resin composition as set forth in claim 1, further comprising at least one thermoplastic resin (F) selected from the group consisting of a phenoxy resin, a polyimide resin, a polyamideimide (PAI) resin, a polyetherimide (PEI) resin, a polysulfone (PS) resin, a polyethersulfone (PES) resin, a polyphenyleneether (PPE) resin, a polycarbonate (PC) resin, a polyetheretherketone (PEEK) resin, and a polyester resin.

5. The insulating epoxy resin composition as set forth in claim 1, wherein the liquid crystal oligomer has a number average molecular weight of 2,500˜6,500.

6. The insulating epoxy resin composition as set forth in claim 1, wherein in the liquid crystal oligomer, an amide is contained in a molar ratio of 12˜30 mole %.

7. The insulating epoxy resin composition as set forth in claim 1, wherein the active ester hardener is obtained by allowing a hardener containing a hydroxy group to react with a compound represented by Chemical Formula 2 below: 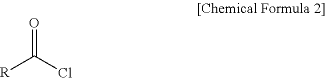
In Chemical Formula 2, R is a C1˜C20 alkyl group, a benzyl group, or a naphthalene group.

8. The insulating epoxy resin composition as set forth in claim 7, wherein the hardener containing a hydroxy group is a phenolic novolac hardener, a dicyclopentadiene based hardener, or a bisphenol A phenolic hardener.

9. The insulating epoxy resin composition as set forth in claim 1, wherein the epoxy resin is at least one selected from a naphthalene based epoxy resin, a bisphenol A epoxy resin, a phenol novolac epoxy resin, a cresole novolac epoxy resin, a rubber modified epoxy resin, and a phosphorous-based epoxy resin.

10. The insulating epoxy resin composition as set forth in claim 1, wherein the inorganic filler is at least one selected from the group consisting of silica, alumina, barium sulfate, talc, mud, a mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titan oxide, barium zirconate, and calcium zirconate.

11. An insulating film manufactured by the insulating epoxy resin composition as set forth in claim 1.

12. A multilayer printed circuit board including the insulating film as set forth in claim 11.
